(19) United States
(12) Patent Application Publication
(10) Pub. No.: US 2011/0013522 A1
(43) Pub. Date: Jan. 20, 2011

(54) COMMUNICATION SYSTEM

(75) Inventor: Tomohisa KISHIGAMI, Oobu-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/837,606

(22) Filed: Jul. 16, 2010

(30) Foreign Application Priority Data
Jul. 17, 2009 (JP) 2009-168877

(51) Int. Cl. H04J 3/14

(52) U.S. Cl. 370/242

(57) ABSTRACT

A communication system is provided, as one aspect, which includes a communication line and a plurality of nodes connected to the communication line, and has a network which is activated based on specific signals sent from two nodes of the plurality of nodes to the communication line. The system includes: a first cold start node and a second cold start node which are connected to the communication line, and activate the network by sending the specific signals to the communication line; and a third cold start node which is connected to the communication line so as to be positioned between the first and second cold start nodes, activates the network by sending the specific signal together with the first or second cold start node, and determines whether or not communication failure has occurred between the plurality of nodes based on a signal transmitted through the communication line.

### CROSS REFERENCE TO RELATED APPLICATION

This application is based on and claims the benefit of priority from earlier Japanese Patent Application No. 2009-168877 filed Jul. 17, 2009, the description of which is incorporated herein by reference.

### BACKGROUND OF THE INVENTION

1. Technical Field of the Invention

The present invention relates to a communication system, in which two or more specific nodes activate a network, and nodes communicate with each other via the network.

2. Related Art

Conventionally, communication systems are known in which, when a plurality of nodes communicate with each other, a network is activated with signals, which act as triggers, from two or more specific nodes of the plurality of nodes.

Techniques for connecting communication lines in the above communication system include non-loop networks (see FIG. 6) and loop networks (see FIG. 7). Since loop networks have low communication speed, non-loop networks are generally employed in communication systems used for vehicles.

FlexRay (trademark) protocol is known which is employed in communication systems in which a network is activated with signals, which act as triggers, from two or more specific nodes of a plurality of nodes (see Japanese Unexamined Patent Application Publication No. 2008-103922).

In the communication systems in which the FlexRay protocol is employed, cold start nodes exist. The cold start nodes wake up based on, for example, the change of power supply from OFF to ON, and activate the network. Specifically, in the communication systems which employ the above protocol, at least two cold start nodes exist which can activate the network. The two cold start nodes arrange the communication schedule by transmitting/receiving signals to/from each other, and activate the network.

Specifically, when activating the network, one of the two cold start nodes (first cold start node) acts as a leading cold start node which transmits a startup frame to the other of the two cold start nodes (second cold start node). When the leading cold start node wakes up in a state where the network is not activated, the leading cold start node transmits to a startup frame to the second cold start node.

The second cold start node acts as a following cold start node. The following cold start node receives the startup frame from the leading cold start node, and transmits a response frame, which responds to the startup frame, to the leading cold start node.

That is, according to the FlexRay protocol, when the leading cold start node and the following cold start node transmit/receive a startup frame and a response frame to/from each other, the two cold start nodes attempt to synchronize with each other. After the synchronization between the cold start nodes is established, the network is activated.

When a non-loop communication system employing the FlexRay protocol is applied to vehicles, one node on the network is generally used as a system monitoring node. Thereby, when the user (for example, a person who maintains the vehicle) examines the vehicle, information indicating the communication states of the nodes (hereinafter, referred to as “diagnosis information”) can be collected from the system monitoring node by using a vehicle diagnosing unit, which makes it easy to obtain the communication state existing between the nodes.

Meanwhile, in a communication system which requires two or more specific nodes (two or more cold start nodes, when the FlexRay protocol is employed) to activate the network, a situation will be considered in which a communication line is broken at one portion due to a detached connector or the like. In this situation, a condition can occur in which one specific node required for activating the network is physically separated by the breaking (breakage), and two or more specific nodes are not connected with the system monitoring node.

In this condition, the network cannot be activated around the system monitoring node, which disables the system monitoring node from detecting the communication states of the nodes. For example, even when the vehicle diagnosing unit is connected to the system monitoring node, nothing can be diagnosed.

Hereinafter, an example of the communication systems employing the FlexRay (trademark) protocol is described with reference to FIG. 6. In this communication system, a communication line is broken.

In FIG. 6, a system monitoring node 100 which is a non-cold start node, cold start nodes 110 to 130, and non-cold start nodes 200 to 250 are connected to a non-loop communication line 300. When the communication line 300 is broken at a point P, the communication system is separated into two areas. The first area is physically disconnected from the system monitoring node 100 by the breaking. The second area is on the system monitoring node 100 side with respect to the broken point P, and is physically connected to the system monitoring node 100 via the communication line 300.

In this case, the cold start nodes 120 and 130 and non-cold start nodes 240 and 250 in the first area are separated from the system monitoring node 100 on the communication line 300.

When such a state occurs, the user attempts to collect diagnosis information from the system monitoring node 100 via a vehicle diagnosing unit 500 to determine whether the communication line 300 is broken or any one of the nodes is broken. However, as shown in FIG. 6, in the second area where the system monitoring node 100 exists, only one cold start node exists which can activate the network.

Hence, the network cannot be activated in the second area, which disables the user from collecting diagnosis information, which indicates current states of the nodes, from the system monitoring node 100. That is, the vehicle diagnosing unit 500 cannot detect what kind of failure has occurred in the communication system.

### SUMMARY OF THE INVENTION

The present invention has been made in consideration of the foregoing conventional situation, and an object of the present invention is to provide a communication system which can activate at least part of a To network when a communication line is broken at one portion.

In order to achieve the object, the present invention provides, as one aspect, a communication system which includes a communication line and a plurality of nodes connected to the communication line, and has a network which is activated based on specific signals sent from two nodes of the plurality of nodes to the communication line, including: a first cold start node and a second cold start node which are connected to the communication line, and activate the network by sending the specific signals to the communication line; and a third cold start node which is connected to the communication line so as to be positioned between the first cold start node and the second cold start node, activates the network by sending the specific signal together with the first cold start node or the second cold start node, and determines whether or not a communication failure has occurred between the plurality of nodes based on a signal transmitted through the communication line.

### BRIEF DESCRIPTION OF THE DRAWINGS

In the accompanying drawings:

FIG. 1 is a block diagram showing a configuration of a communication system;

FIG. 2A is a flowchart showing a system monitoring process executed by a microcomputer of a monitoring ECU;

FIG. 2B is a flowchart showing a diagnosis information outputting process;

FIGS. 3A and 3B are diagrams showing the relationship between a breaking point and an area in which a network can be activated;

FIG. 4A is a block diagram showing hardware configurations of a monitoring ECU and a monitored ECU in a communication system employing the differential signaling scheme;

FIG. 4B is a diagram showing an example of the communication system in which only one signal transmission line is broken;

FIG. 5 is a block diagram showing the configuration of a communication system in which a monitoring ECU has a gateway function;

FIG. 6 is a diagram regarding a conventional art; and

FIG. 7 is a diagram regarding a conventional art.

### DETAILED DESCRIPTION OF THE PREFERRED EMBODIMENTS

Hereinafter, embodiments of the present invention will now be described in connection with the accompanying drawings. In the embodiments set forth below, the components identical with or similar to each other are given the same reference numerals for the sake of omitting explanation.

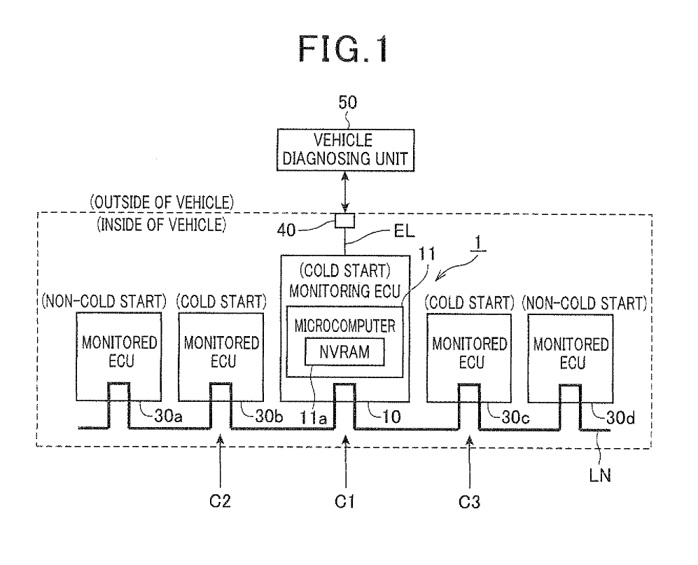

FIG. 1 is a block diagram showing a configuration of a communication system 1 of the present embodiment.

In the communication system 1, a plurality of electronic control units 10, 30a, 30b, 30c, and 30d are connected to a common non-loop communication line LN. Each of the electronic control units 10, 30a, 30b, 30c, and 30d communicates with another of the electronic control units via the non-loop communication line LN.

Specifically, the electronic control unit 10 is configured as an electronic control unit for monitoring the system and includes a microcomputer 11. The microcomputer 11 executes a program to monitor frames (communication signals) transmitted from the electronic control units 30a, 30b, 30c, and 30d which are connected to the communication line LN. When the electronic control unit 10 detects the electronic control unit in which communication failure has occurred, the electronic control unit 10 stores the detection result in an NVRAM 11a as diagnosis information.

Hereinafter, the electronic control unit 10 is referred to as a monitoring ECU 10, and the electronic control units 30a, 30b, 30c, and 30d monitored by the electronic control unit 10 is referred to as monitored ECUs 30a, 30b, 30c, and 30d. The monitored ECUs 30a, 30b, 30c, and 30d are also collectively referred to as monitored ECUs 30.

In addition, the monitoring ECU 10 is connected to a connector 40 via an exclusive line EL. The connector 40 is disposed on the boundary between the inside and the outside of a vehicle. A vehicle diagnosing is unit 50 is attachable to and detachable from the connector 40 outside the vehicle. That is, the monitoring ECU 10 can provide diagnosis information to the vehicle diagnosing unit 50, which is connected to the connector 40, via the exclusive line EL.

The communication system 1 of the present embodiment is configured as a communication system for vehicles. The monitored ECUs 30a, 30b, 30c, and 30d are configured with various electronic control units (ECUs) such as control system ECUs and body system ECUs.

For example, the control system ECUs include an engine ECU for controlling an engine, a brake ECU for controlling a brake, a steering ECU for controlling a steering system, and a suspension ECU for controlling suspension. The body system ECUs include an ECU for controlling doors to be locked/unlocked, and an ECU for controlling lights to be turned on/off. In the present embodiment, although four monitored ECUs are shown, the number of the monitored ECUs is not limited.

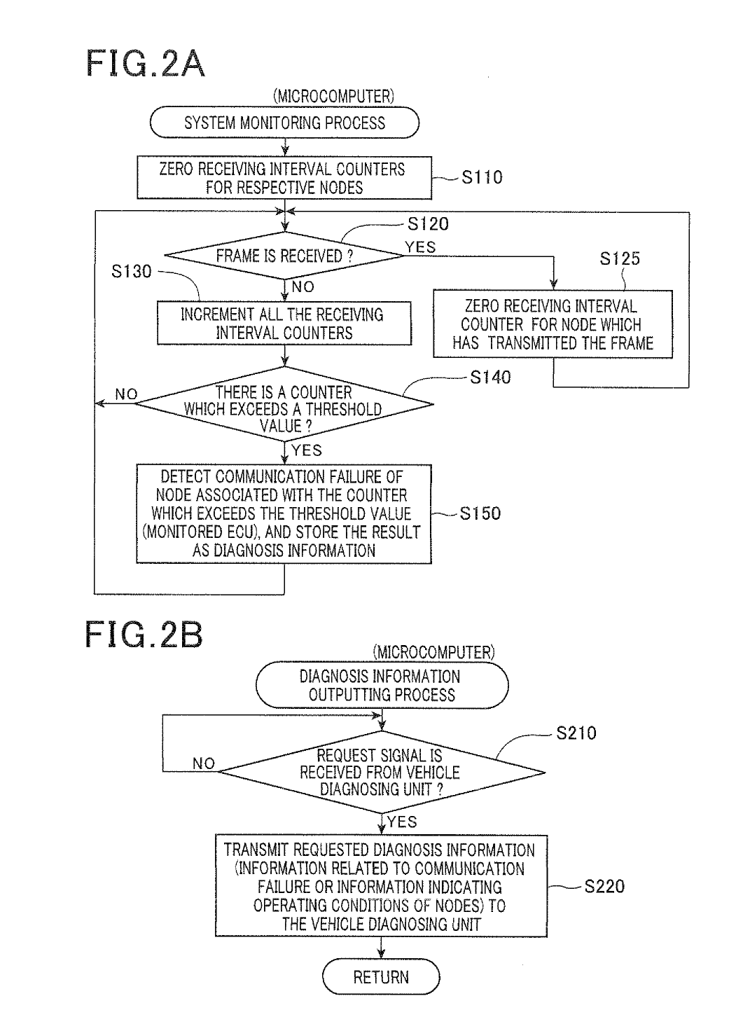

In the monitoring ECU 10, the microcomputer 11 executes a system monitoring process shown in FIG. 2A. When the monitoring ECU 10 detects the monitored ECU 30 in which communication failure has occurred, the monitoring ECU 10 stores the detection result in the NVRAM 11a as diagnosis information.

FIG. 2A is a flowchart showing the system monitoring process executed by the microcomputer 11.

When the microcomputer 11 starts the system monitoring process, the microcomputer 11 zeros receiving interval counters for the respective monitored ECUs 30a, 30b, 30c, and 30d connected to the communication line LN (S110).

Thereafter, the microcomputer 11 determines whether or not the microcomputer 11 has received a frame from the monitored ECUs 30 via the communication line LN (S120). When the microcomputer 1 has received a frame (“Yes” in S120), the microcomputer 11 zeros the receiving interval counter for the source unit which has transmitted the frame. Thereby, the interval for receiving a frame from the source unit is reset to zero (S125). Thereafter, the microcomputer 11 proceeds to the process in S220.

When the microcomputer 11 has not received a frame from the monitored ECUs 30 (“No” in S120), the microcomputer 11 increments the count value of the respective receiving interval counters to update the elapsed time, which is indicated by the receiving interval counters, from the time at which the last frame is received (S130).

Thereafter, the microcomputer 11 determines whether or not there is a receiving interval counter, which is included in the receiving interval counters for the monitored ECUs 30a, 30b, 30c, and 30d, whose count value exceeds a predetermined threshold value (S140). When there is no receiving interval counter whose count value exceeds the predetermined threshold value, the microcomputer 11 proceeds to the process in S120.

When there is a receiving interval counter whose count value exceeds the predetermined threshold value, the microcomputer 11 determines that the monitored ECU 30, which is associated with the receiving interval counter whose count value exceeds the predetermined threshold value, is an electronic control unit in which communication failure has occurred and communication cannot be performed. The microcomputer 11 stores the identification information of the electronic control unit in an NVRAM 11a as diagnosis information (S150). Thereafter, the microcomputer 11 proceeds to the process in S120.

As described above, the monitoring ECU 10 monitors the operation of the monitored ECUs 30, and stores information of the monitored ECU 30, in which communication failure has occurred, as diagnosis information.

The communication system 1 can employ, for example, the FlexRay (trademark) protocol which is a time-trigger communication protocol. When a time-trigger communication protocol such as the FlexRay protocol is employed, each of the nodes transmits a frame by using a previously assigned slot in a predetermined communication cycle.

In particular, in the communication system 1 configured with electronic control units for vehicles, each of the electronic control units (monitored ECUs 30) stores output values of sensors and the like, which are used for associated vehicle control, in a frame every one period or multiple periods. Each of the electronic control units outputs the frame to the communication line LN. Hence, the threshold value used in S140 can be set to, for example, a value corresponding to a time interval which is three to ten times the communication cycle.

As shown in FIG. 2B, when the microcomputer 11 of the monitoring ECU 10 receives a request signal for diagnosis information from the vehicle diagnosing unit 50 (“Yes” in S210), the microcomputer 11 reads the diagnosis information associated with the request signal from the NVRAM 11a. The microcomputer 11 transmits the diagnosis information to the vehicle diagnosing unit 50 connected to the connector 40 (S220). FIG. 2B is a flowchart showing a diagnosis information outputting process which is repeatedly executed by the microcomputer 11 of the monitoring ECU 10.

The diagnosis information transmitted to the vehicle diagnosing unit 50 includes not only the diagnosis information related to the communication failure described above but also the diagnosis information indicating operating conditions of the monitored ECUs 30 stored therein.

The monitored ECUs 30 store the diagnosis information indicating normality/abnormality of respective functions thereof, which is the diagnosis information indicating operating conditions of the monitored ECUs 30. In response to the request from the monitoring ECU 10, the monitored ECUs 30 transmit the diagnosis information to the monitoring ECU 10 via the communication line LN.

In response to the request from the vehicle diagnosing unit 50, the monitoring ECU 10 transmits the diagnosis information indicating the operating conditions of the monitored ECUs 30 to the vehicle diagnosing unit 50 via the connector 40.

The monitoring ECU 10 may periodically obtain the diagnosis information indicating the operating conditions from the monitored ECUs 30 via the communication line LN, and store the diagnosis information in the NVRAM 11a. When the monitoring ECU 10 receives a request from the vehicle diagnosing unit 50, in S220, the monitoring ECU 10 may read the required diagnosis information from the NVRAM 11a, and may transmit the diagnosis information to the vehicle diagnosing unit 50. When the monitoring ECU 10 receives a request from the vehicle diagnosing unit 50, in S220, the monitoring ECU 10 may obtain the diagnosis information indicating the operating conditions from the monitored ECUs 30, and may transmit the diagnosis information to the vehicle diagnosing unit 50 without storing the diagnosis information in the NVRAM 11a.

Meanwhile, in the communication system 1 for vehicles, the electronic control units (the monitoring ECU 10 and the monitored ECUs 30) are not always in a waking state. When the user ends the operation of the vehicle, the electronic control units shift to a sleep state or a power-off state.

That is, when the vehicle diagnosing unit 50 diagnoses the vehicle, the electronic control units (the monitoring ECU 10 and the monitored ECUs 30) are not always in an activated state. The network may be in a non-activated state. Note that the non-activated state of the network means a state in which communication has not yet been prepared to be started, and normal communication has not yet been started between the nodes.

The monitoring ECU 10 of the present embodiment monitors the system when the network is in the activated state. In the non-activated state of the network, when the user connects the vehicle diagnosing unit 50 to the connector 40 to obtain monitoring results, the monitoring ECU 10 is activated when the user turns on the ignition key to supply power. When the monitoring ECU 10 is in the sleep state, the monitoring ECU 10 wakes up when receiving a trigger signal from the vehicle diagnosing unit 50. Then, the monitoring ECU 10 transmits a wake-up signal for waking other nodes up to the communication line LN. Thereby, the monitored ECUs 30 connected to the communication line LN are waked up.

In the communication system 1, two electronic control units send specific signals which act as triggers for activating the network to the communication line LN to activate the network. The two electronic control units are included in the electronic control units which are waked up (or supplied with power). The two electronic control units are previously set to cold start nodes which can activate the network.

When activating the network as described above, the monitoring ECU 10 waits predetermined time. After that, the monitoring ECU 10 starts the system monitoring process shown in FIG. 2A. The monitoring ECU 10 wafts predetermined time in consideration of the time lag in which the nodes enter the network.

When the time has elapsed which is previously determined as the time longer than the threshold value set in S140, the monitoring ECU 10 presumes that the latest information regarding communication failure is stored in the NVRAM 11a. Then, the monitoring ECU 10 starts the process shown in FIG. 2B. The monitoring ECU 10 receives a request signal for diagnosis information from the vehicle diagnosing unit 50. In accordance with the request signal, the monitoring ECU 10 transmits the diagnosis information (information regarding communication failure) stored in the NVRAM 11a to the vehicle diagnosing unit 50 connected to the connector 40.

In this case, the monitoring ECU 10 may start another process in parallel with the above system monitoring process. In this other process, the monitoring ECU 10 collects diagnosis information indicating the above operating conditions, which are collected by the monitored ECUs 30, from the monitored ECUs 30. The monitoring ECU 10 stores the collected diagnosis information in the NVRAM 11a.

Next, the arrangement of the cold start nodes of the communication system 1 will be described with reference to FIG. 1. As shown in FIG. 1, the monitoring ECU 10 is set to a cold start node, and the monitored ECUs 30b and 30c are also set to cold start nodes. The monitored ECUs 30b and 30c are connected to the communication line LN at left side and right side positions with respect to the monitoring ECU 10. Note that the monitored ECUs 30a and 30d are set to non-cold start nodes, which do not have a function for activating the network, and enter the network when the network is activated.

That is, the communication system 1 is configured so that a connecting position C1 of the monitoring ECU 10 on the communication line LN is between connecting positions C2 and C3 of other two cold start nodes. The cold start nodes are arranged as describe above for the reason that the communication system 1 requires two cold start nodes to activate the network.

As a communication protocol requiring two cold start nodes to activate the network, the FlexRay (trademark) protocol is known as described above. In the FlexRay protocol, a time-trigger method is employed. When the network is activated, the nodes attempt to synchronize with each other, and the communication schedule (the base point and the period of the communication cycle) is required to be arranged.

For this reason, the two cold start nodes transmit/receive a startup frame and a response frame corresponding to the startup frame, which are the specific signals, to/from each other via the communication line LN. Thereby, synchronization is established, and the communication schedule is arranged, which activates the time-triggered network.

However, in the communication system which requires two cold start nodes to activate the network, when the communication line LN is broken, the physical connection between the cold start nodes is broken. Thereby, the network cannot be activated in the area in which two cold start nodes are not physically connected with each other (for example, the second area shown in FIG. 6), which disable the nodes from communicating with each other. Note that the communication line LN is often broken when a cable constituting the communication line LN is detached from a connector of an electronic control unit due to some sort of external force.

When the monitoring ECU 10 exists in such an area in which the network cannot be activated, the monitoring ECU 10 can no longer store useful diagnosis information regarding communication failure in the NVRAM 11a.

To solve this program, in the present embodiment, the monitoring ECU 10 is set to be a cold start node, and is disposed between other cold start nodes.

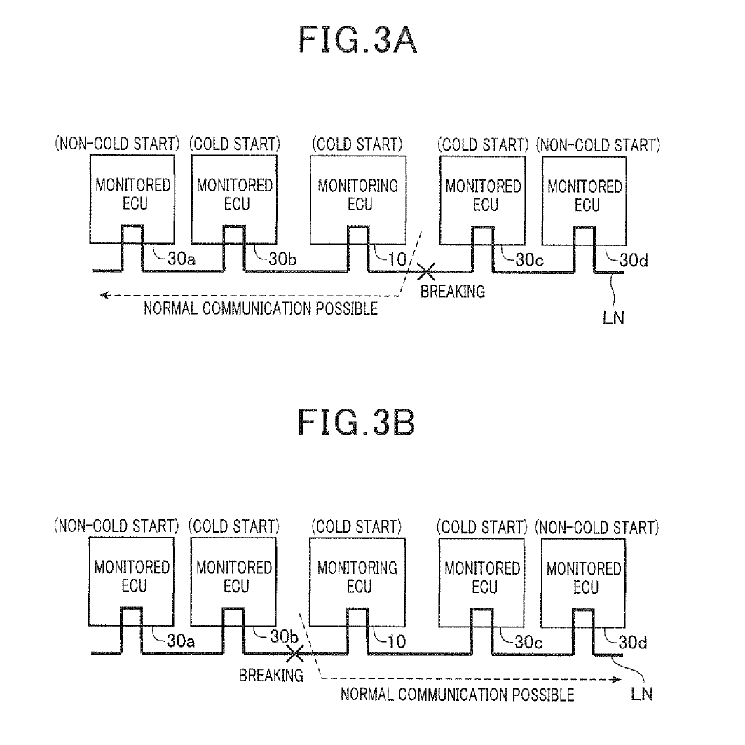

According to the communication system 1 configured as described above, as shown in FIG. 3A, even when the communication line LN is broken at the right side with respect to the connecting position of the monitoring ECU 10, the physical connection between the monitoring ECU 10 and the monitored ECU 30b, which are cold start nodes, can be maintained. As shown in FIG. 3B, even when the communication line LN is broken at the left side with respect to the connecting position of the monitoring ECU 10, the physical connection between the monitoring ECU 10 and the monitored ECU 30c can be maintained.

According to the present embodiment, in the communication system 1 which requires two cold start nodes to activate the network and has the non-loop communication line LN, even when the communication line LN is broken at one portion, at least part of the network including the monitoring ECU 10 can be activated. That is, in the communication system 1, as long as the communication line LN is broken at only one portion, two cold start nodes, which are either the monitoring ECU 10 and the monitored ECU 30b or the monitoring ECU 10 and the monitored ECU 30c can transmit signals required for activating the network to reliably activate the network in an area where the monitoring ECU 10 exists.

Since the network can be activated as described above, in the present embodiment, the monitoring ECU 10 can monitor the operation of the monitored ECU 30s, which are positioned in an area on the monitoring ECU 10 side with respect to the broken point, regardless of the breaking (breakage) of the communication line LN. The monitoring ECU 10 can store the diagnosis information regarding communication failure and other malfunctions of the monitored ECU 30s in the NVRAM 11a.

Since the above diagnosis information can be stored in the NVRAM 11a, in the communication system 1 of the present embodiment, significant diagnosis information which is useful for locating the breaking can be stored in the NVRAM 11a.

The monitoring ECU 10 cannot receive frames from the monitored ECU 30s, which are physically unable to communicate with the monitoring ECU 10 due to the breaking. However, the monitoring ECU 10 can receive frames transmitted from the monitored ECU 30s, which are able to communicate with the monitoring ECU 10. Therefore, whether or not the a communication failure has occurred due to line breaking, and the position of any breaking on the communication line LN can be easily detected based on the positional relationship between the electronic control unit which can receive frames identified by the diagnosis information and the electronic control unit which cannot receive frames identified by the diagnosis information.

Therefore, according to the present embodiment, when the communication line LN is broken, the vehicle diagnosing unit 50 can quickly and easily solve the trouble by collecting the diagnosis information from the monitoring ECU 10 and analyzing the diagnosis information.

Specifically, according to the present embodiment, the vehicle diagnosing unit 50 and the monitoring ECU 10 are connected with each other via the exclusive line EL. Hence, even when the communication line LN is broken, the monitoring ECU 10 can continue to provide the diagnosis information to the vehicle diagnosing unit 50. That is, the monitoring ECU 10 can reliably provide the diagnosis information to the vehicle diagnosing unit 50 in which the diagnosis information is useful to detect malfunctions of the vehicle.

In addition, according to the present embodiment, no non-cold start node is disposed between the connecting position C1 of the monitoring ECU 10 on the communication line LN and the connecting positions C2 and C3 of other two cold start nodes. The cold start nodes are adjacently arranged to reduce the area in which the connection between the monitoring ECU 10 and other two cold start nodes (the monitored ECUs 30b and 30c) is broken when the communication line is broken. Thereby, the communication system 1 can be provided which has resistance to the breaking at a plurality of portions of the communication line.

In the above embodiment, the communication system 1 includes both of the cold start nodes and the non-cold start nodes. However, the communication system 1 may not include the non-cold start nodes. That is, the non-cold start nodes are not essential elements.

Note that the communication system 1 for vehicles often employs the differential signaling scheme, which is a signal transmission scheme having resistance to noise, in consideration of the effect of noise on the communication. According to the differential signaling scheme, as described above, a communication line is configured with two (a pair of) signal transmission lines. A communication signal communicated between nodes is represented by the voltage difference of signals (differential signals) transmitted through the two signal transmission lines.

In the communication system 1 employing the differential signaling scheme, in the case where one of the two signal transmission lines is broken, which is not the case where the two signal transmission lines are simultaneously broken due to a detached connector or the like, disadvantages can be caused depending on the number of the cold start nodes provided in the communication system 1, Therefore, in the communication system 1 employing the differential signaling scheme, it is preferable to limit the number of the cold start nodes.

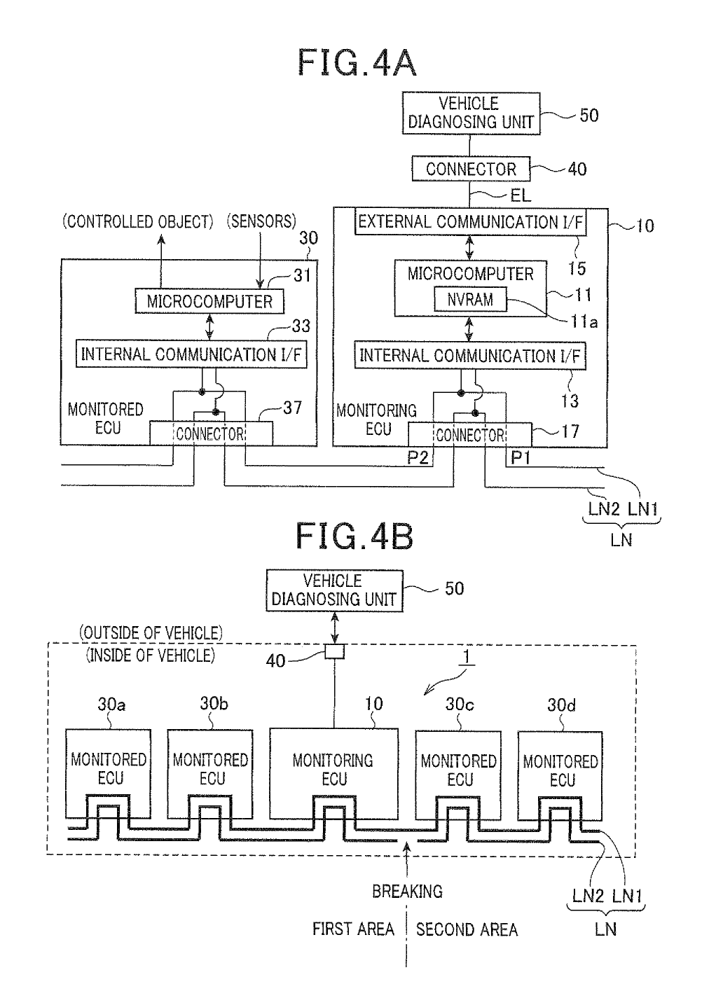

Next, the configuration of the communication system 1 employing the differential signaling scheme will be described with reference to FIG. 4A. FIG. 4A is a block diagram showing hardware configurations of the monitoring ECU 10 and the monitored ECU 30 in the communication system 1 employing the differential signaling scheme. Note that the basic hardware configurations of the monitored ECUs 30a, 30b, 30c, and 30d are the same.

In the communication system 1, the monitoring ECU 10 includes the microcomputer 11, an internal communication interface 13 which relays signals communicated between the microcomputer 11 and the communication line LN, an external communication interface 15 which relays signals communicated between the microcomputer 11 and the vehicle diagnosing unit 50, and a connector 17 for drawing the communication line LN into the ECU.

The external communication interface 15 is connected to the connector 40 via the exclusive line EL. The connector 40 is disposed on the boundary between the inside and the outside of the vehicle. The vehicle diagnosing unit 50 is attachable to and detachable from the connector 40. The external communication interface 15 transmits a communication signal, which is transmitted from the vehicle diagnosing unit 50 connected to the connector 40, to the microcomputer 11. The external communication interface 15 transmits a communication signal, which is transmitted from the microcomputer 11, to the vehicle diagnosing unit 50 via the connector 40.

The connector 17 includes two ports P1 and P2 to which communication cables constituting the communication line LN are connected. The ports P1 and P2 are connected to each other in the electronic control unit so that signals can be transmitted. Due to the connector 17, the communication line LN is drawn into the monitoring ECU 10. Note that since the differential signaling scheme is employed, the communication line LN is configured with two signal transmission lines LN1 and LN2.

The internal communication interface 13 is connected to the two signal transmission lines LN1 and LN2. The internal communication interface 13 converts a communication signal for the inside of the vehicle, which is outputted from the microcomputer 11, into differential signals which use positive logic and negative logic. The internal communication interface 13 outputs one of the differential signals to the signal transmission line LN1, and outputs the other of the differential signals to the signal transmission line LN2. The internal communication interface 13 converts differential signals which use positive logic and negative logic, which is inputted from the signal transmission lines LN1 and LN2, into a received signal which uses the voltage difference of the differential signals. The internal communication interface 13 inputs the received signal into the microcomputer 11. In addition, the microcomputer 11 executes a communication control process based on the communication protocol employed in the communication system 1, which realizes communication with other nodes (monitored ECUs 30) connected to the communication line LN.

The monitored ECU 30 also includes, as with the monitoring ECU 10, a microcomputer 31, an internal communication interface 33 which relays signals communicated between the microcomputer 31 and the communication line LN, and a connector 37 for drawing the communication line LN into the ECU. The internal communication interface 33 converts a communication signal for the inside of the vehicle, which is outputted from the microcomputer 31, into differential signals. The internal communication interface 33 outputs the differential signals to the two signal transmission lines LN1 and LN2 constituting the communication line LN. The internal communication interface 33 converts differential signals transmitted through the signal transmission lines LN1 and LN2 into a received signal corresponding to the voltage difference of the differential signals. The internal communication interface 33 inputs the received signal into the microcomputer 31.

Next, in the communication system 1 in which the monitoring ECU 10 and the monitored ECUs 30 are configured as described above, a case will be considered in which one of the two signal transmission lines LN1 and LN2 constituting the communication line LN is broken. FIG. 4B is a diagram showing an example of the communication system 1 in which only the signal transmission line LN2 is broken.

In this case, one of the two differential signals is not communicated between the first area and the second area because the signal transmission line is broken. However, the other of the two differential signals is communicated between the first area and the second area because the signal transmission line is not broken.

When four or more cold start nodes including the monitoring ECU 10 are provided on the communication line LN and only one signal transmission line is broken, a case occurs in which two or more cold start nodes exist in each of the first area and the second area. In such a case, although the network is activated in each of the areas, communication signals of the areas leak through the signal transmission line which is not broken. Thereby, the communication signal represented by the voltage difference of two differential signals is distorted, which makes the network unstable.

Therefore, when the communication system 1 employs the differential signaling scheme as a signal transmission scheme, as shown in FIG. 1, it is preferable to provide only three cold start nodes on the communication line LN. As shown in FIG. 1, the two monitored ECUs 30b and 30c, which are cold start nodes, are provided on both sides of the monitoring ECU 10, which is a cold start node. Other cold start nodes are provided on neither of the sides of the monitoring ECU 10. In the case where only three cold start nodes are connected to the communication line LN as described above, even when one of the two signal transmission lines LN1 and LN2 constituting the communication line LN is broken, the network is not activated in both the two areas separated from each other by the breaking (the network is activated in one of the two areas separated by the breaking). Thereby, the network can be prevented from becoming unstable due to the interference between the divided parts of the network.

That is, when only three cold start nodes are provided, only one pair of cold start nodes is established, which can prevent the network from becoming unstable due to the mutual interference caused when two networks are activated.

Assuming that the communication system 1 employs the FlexRay (trademark) protocol, when optical communication is performed using an optical fiber for the communication line LN, the communication line LN is a single wire and does not use the differential signaling scheme. However, when electrical communication is performed, the signal transmission scheme is limited to the differential signaling scheme. Therefore, in the communication system 1 performing electric communication, when the FlexRay protocol is employed, it is preferable to provide only three cold start nodes in the communication system 1 based on the above concept.

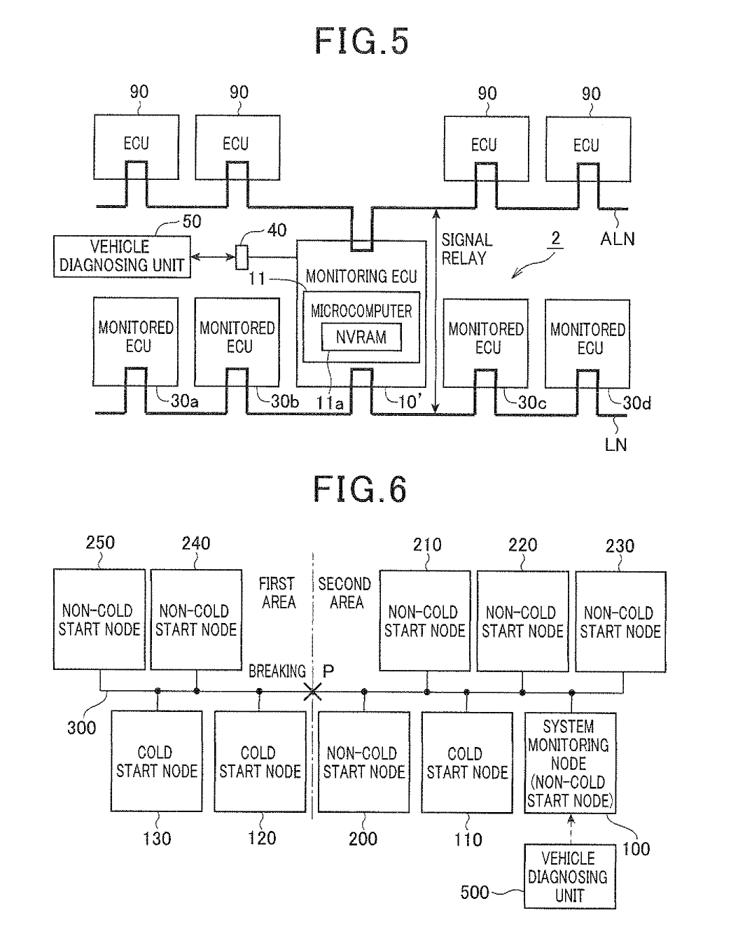

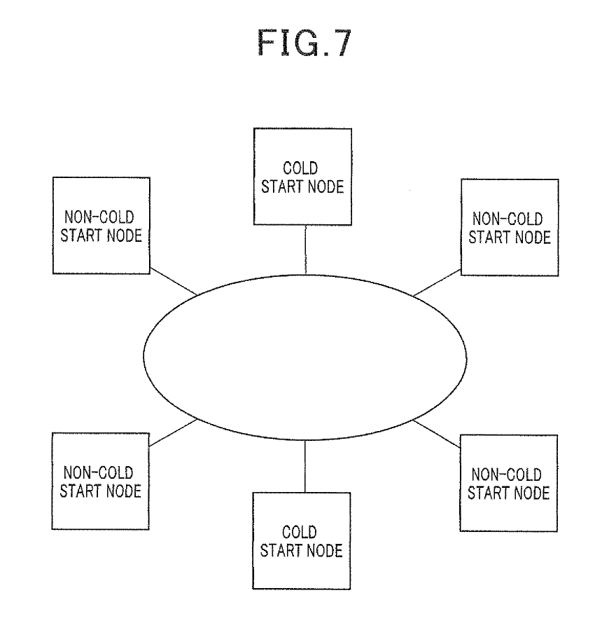

In addition, the monitoring ECU 10 may be connected to a communication line ALN (see FIG. 5) independent of the communication line to which the monitored ECUs 30a, 30b, 30c, and 30d are connected. The monitoring ECU 10 functions as a gateway unit which relays communication between the monitored ECUs 30a, 30b, 30c, and 30d connected to the communication line LN and the nodes (electronic control units 90) connected to the communication line ALN. FIG. 5 is a block diagram showing the configuration of a communication system 2 in which a monitoring ECU 10′ functions as a gateway unit. The monitoring ECU 10′ configured as described above monitors not only the monitored ECUs 30a, 30b, 30c, and 30d connected to the communication line LN but also the nodes (electronic control units 90) connected to the communication line ALN. Thereby, communication failure of the nodes can be detected, which provides an advantage that the communication lines LN and ALN are not required to be provided with system monitoring nodes individually.

The function of the monitoring ECU 10 may be provided in other electronic control units such as a brake ECU. Integrating the function of the monitoring ECU 10 into other electronic control units such as a brake ECU reduces the cost of manufacturing the communication system 1.

The monitored ECUs 30b and 30c correspond to first and second cold start nodes. The monitoring ECUs 10 and 10′ connected to the communication line LN correspond to a third cold start node. A connector 40 corresponds to a connector which is provided to the third cold start node. An external unit is connected to the connector. The external unit is attachable to and detachable from the connector outside the vehicle.

It will be appreciated that the present invention is not limited to the configurations described above, but any and all modifications, variations or equivalents, which may occur to those who are skilled in the art, should be considered to fall within the scope of the present invention.

For example, the present invention is not limited to a communication system employing the FlexRay (trademark) protocol and a time-triggered communication system requiring synchronization between the nodes. The present invention can be applied to is communication systems employing various communication protocols. In addition, the present invention can be applied to not only in-vehicle communication systems but also other various communication systems.

In the above embodiments, the communication line LN is drawn into the electronic control units 10 and 30. Alternatively, as shown in FIG. 6, the electronic control units 10 and 30 may be connected to lines branching off from the communication line LN. If the branch line extends outside the electronic control unit, the branch line takes loads when an electronic control unit is attached to or detached from the branch line, which increases the possibility of the breaking of the branch line. It is preferable to provide the branch line inside the electronic control unit as in the case of the above embodiments.

Hereinafter, aspects of the above-described embodiments will be summarized.

The communication system of the embodiment includes a non-loop communication line and a plurality of nodes connected to the communication line, and has a network which is activated based on specific signals sent from two nodes of the plurality of nodes to the communication line.

The communication system includes first and second cold start nodes which are connected to the communication line, and activate the network, which is in a non-activated state, by sending the specific signals to the communication line.

The communication system further includes a third cold start node which activates the network, which is in a non-activated state, by sending the specific signal to the communication line together with the first cold to start node or the second cold start node, and thereafter determines whether or not communication failure has occurred between the plurality of nodes based on a signal transmitted through the communication line. Then, the third cold start node sends the determination result to the outside of the network (externally to the network, to an external unit).

In addition, the third cold start node is connected to the communication line so as to be positioned between the first cold start node and the second cold start node.

According to the communication system described above, the position of the third cold start node connected to the communication line is between the first cold start node and the second cold start node. Thus, the first cold start node and the second cold start node, which can activate the network, exist at the left and right sides of the third cold start node.

Therefore, even when the communication line is broken due to a detached connector or the like at the right side or left side of the third cold start node, the connection between the third cold start node and at least one of the first cold start node and the second cold start node by the communication line can be maintained (see FIG. 3). Thereby, according to the communication system, as long as the communication line is broken at only one portion, the network can be activated in an area where at least the third cold start node exists by transmitting the specific signals from the two cold start nodes.

According to the embodiment, the case can be prevented where the network of the whole communication system cannot be activated due to the breaking at one portion. Hence, after the line breaking, the third cold start node can determine normality/abnormality of the communication state between the nodes.

Therefore, sending the determination result externally to the network enables the useful information to be transmitted to units outside the network. The information is useful for determining whether the failure occurring in the communication system is due to each of the nodes or the breaking, and is useful for identifying the position of the breaking.

In the above communication system, the nodes which activate the network may be exclusively the first, second, and third cold start nodes.

In particular, the communication system in which only three nodes can activate the network is useful for a system, in which the communication line includes a pair of signal transmission lines, and the nodes connected to the communication line use the signal transmission lines and transmit/receive signals to/from each other by using a differential signaling scheme.

According to the differential signaling scheme, a signal using positive logic is inputted into one of the two signal transmission lines, and a signal using negative logic is inputted into the other of the two signal transmission lines. Then, communication signal transmitted between the nodes is represented by the voltage difference of the signals transmitted through the two signal transmission lines (differential signals).

Therefore, when one of the two signal transmission lines is broken, one of the differential signals is not communicated between two areas of the signal transmission line which is divided by the broken. However, the other of the differential signals is communicated through the whole area of the signal transmission line, which distorts the communication signal transmitting across the breaking portion.

Hence, in the communication system using the differential signaling scheme, when four or more cold start nodes are provided and one of the two signal transmission lines is broken, communication signals in the network activated in one of the two areas, which have been divided by the breaking, leak to the other area, which makes the third cold start node unstable.

In addition, in the communication system using the differential signaling scheme, when only the first, second, and third cold start nodes are provided as the nodes which can activate the network, the problem that the network becomes unstable can be solved, which provides a system having resistance to the line breaking.

In addition, in the communication system which includes a non-cold start node, which does not have a function for activating the network and enters the network when the network is activated, in addition to the cold start node which can activate the network, the third cold start node is preferably connected to the communication line in the following positional relationship.

That is, the third cold start node is preferably connected to the communication line in a state where the non-cold start node is not positioned between the first cold start node and the second cold start node. In other words, the first and second cold start nodes are preferably disposed so as to be adjacent to the third cold start node on the communication line.

When the third cold start node is connected to the communication line as described above, physical connections between the third cold start node and first and second cold start nodes can be ensured unless the breaking occurs in a limited space between the respective cold start nodes on the communication line. Therefore, the communication system can be provided which has resistance to the breaking at a plurality of portions of the communication line.

In addition, in the communication system installed in a vehicle, the third cold start node may include a connector which transmits the determination result externally to the network and to which an external unit is connected.

According to the communication system described above, the user can recognize the communication failure in the communication system and easily determine the cause of the failure by simply connecting a vehicle diagnosing unit, which is the external unit, to the communication system via the connector and performing simple operation.

In particular, according to the communication system of the embodiment, the vehicle diagnosing unit can connect to the third cold start node via the connector, which is a path independent of the communication line, and can collect the information regarding the communication failure from the third cold start node. Hence, the information can be collected without being affected by the breaking and more reliably than the case where the information is collected from the third cold start node via the communication line which has broken.

In addition, the third cold start node may be configured to transmit the information, which is collected via the communication line and indicates operation conditions of the nodes connected to the communication line, in addition to the determination result, externally to the network via the connector.

For example, the third cold start node can obtain the information indicating normality/abnormality of functions included in the nodes connected to the communication line, as the information indicating the operation conditions, from the nodes via the communication line. Then, the third cold start node can transmit the information externally to the network via the connector. According to the communication system described above, information more useful for diagnosing the vehicle can be provided to the outside of the network via the connector.

The embodiment can be applied to the communication system which includes a time-triggered network in which two of the first to third cold start nodes transmit/receive the specific signals to/from each other via the communication line, whereby synchronism between the nodes is established, and the network is activated. This type of network includes a network based on the FlexRay (trademark) protocol.

To activate this type of network, the network requires two cold start nodes. Hence, applying the embodiment to the network can configure a communication system having resistance to the breaking.

In addition, the third cold start node may be connected to a first communication line which is the above communication line and to which the first and second cold start node are connected, and may be connected to a second communication line. Thereby, the third cold start node is configured as a gateway unit which relays communication between the node connected to the first communication line and the node connected to the second communication line.

According to the communication system described above, the third cold start node can transmit the determination result between the nodes on the first communication line to the node connected to the second communication line. In addition, the third cold start node can transmit the determination result between the nodes on the first communication line and the determination result between the nodes on the second communication line to an external unit such as the vehicle diagnosing unit. Thereby, useful communication system can be provided.

What is claimed is:

1. A communication system which includes a communication line and a plurality of nodes connected to the communication line, and has a network which is activated based on specific signals sent from two nodes of the plurality of nodes to the communication line, comprising:
a first cold start node and a second cold start node which are connected to the communication line, and activate the network by sending the specific signals to the communication line; and
a third cold start node which is connected to the communication line so as to be positioned between the first cold start node and the second cold start node, activates the network by sending the specific signal together with the first cold start node or the second cold start node, and determines whether or not communication failure has occurred between the plurality of nodes based on a signal transmitted through the communication line.

2. The communication system according to claim 1, wherein the third cold start node sends the determination result externally to the network.

3. The communication system according to claim 1, wherein the nodes which activate the network by sending the specific signal are exclusively the first, second, and third cold start nodes.

4. The communication system according to claim 3, wherein
the communication line includes a pair of signal transmission lines, and
the nodes connected to the communication line use the signal transmission lines and transmit/receive signals to/from each other by using a differential signaling scheme.

5. The communication system according to claim 1, further comprising a non-cold start node which is connected to the communication line, and enters the network when the network is activated, wherein
the third cold start node is connected to the communication line in a state where the non-cold start node is not positioned between the first cold start node and the second cold start node.

6. The communication system according to claim 1, wherein
the communication system is installed in a vehicle, and
the third cold start node includes a connector which transmits the determination result externally to the network and to which an external unit is connected.

7. The communication system according to claim 6, wherein
the third cold start node transmits information indicating operating conditions of the nodes collected from the nodes via the communication line externally to the network via the connector.

8. The communication system according to claim 1, wherein
the network is a time-triggered network in which two of the first to third cold start nodes transmit/receive the specific signals to/from each other via the communication line, whereby synchronization between the nodes is established, and the network is activated.

9. The communication system according to claim 1, wherein
the third cold start node is connected to a first communication line which is the communication line and to which the first and second cold start node are connected, and is connected to a second communication line, whereby the third cold start node is configured as a gateway unit which relays communication between the node connected to the first communication line and the node connected to the second communication line.
